(19) United States
(12) Patent Application Publication
(10) Pub. No.: US 2005/0270988 A1
(43) Pub. Date: Dec. 8, 2005

(54) Mechanism of dynamic upstream port selection in a PCI express switch

(76) Inventor: Eric DeHaemer, Shrewsbury, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/861,169

(22) Filed: Jun. 4, 2004

(51) Int. Cl. H04J 3/24

(52) U.S. Cl. 370/254

(57) ABSTRACT

A PCI Express switch with ports defined to begin operation as upstream ports, and configured to perform a link training that determines when one port is connected to an upstream device and directs the other ports to operate as downstream ports.

### BACKGROUND

The Peripheral Component Interconnect (PCI) Express architecture is an I/O interconnect architecture that is intended to support a wide variety of computing and communications platforms. The PCI Express architecture describes a fabric topology in which the fabric is composed of point-to-point links that interconnect a set of devices. For example, a single fabric instance (referred to as a “hierarchy”) can include a Root Complex (RC), multiple endpoints (or I/O devices) and a switch. The switch supports communications between the RC and endpoints, as well as peer-to-peer communications between endpoints.

The PCI Express architecture is specified in layers, including software layers, a transaction layer, a data link layer and a physical layer. The software layers generate read and write requests that are transported by the transaction layer to the data link layer using a packet-based protocol. The data link layer adds sequence numbers and CRC to the transaction layer packets. The physical layer transports data link packets between the data link layers of two PCI Express agents. The physical layer supports “x N” link widths, that is, links with N lanes (where N can be 1, 2, 4, 8, 12, 16 or 32). The physical layer byte stream is divided so that bytes are transmitted in parallel across the lanes.

During link training, each PCI Express link is set up following a negotiation of link widths, frequency of operation and other parameters by the ports at each end of the link. The ports in the PCI Express devices, such as the RC, switch and endpoints, each are pre-configured statically in hardware for dedicated use as an upstream port or a downstream port.

### DESCRIPTION OF DRAWINGS

FIG. 1 is a block diagram of a PCI Express processing platform including a root complex, switch and endpoints.

FIG. 2 is block diagram showing switch ports with state machine control logic to support dynamic upstream port selection.

FIG. 3 is a high-level state diagram of a PCI Express link training procedure.

FIG. 4 is a state diagram of a Configuration sub-state machine in the switch ports.

FIG. 5 is a state diagram illustrating the interaction between root complex, switch and endpoint during the Configuration state.

FIG. 6 is a block diagram of a PCI Express processing platform with root complex redundancy.

FIG. 7 is a diagram depicting a system environment in which a PCI Express processing platform is connected to a PCI Express I/O sub-system by an Advanced Switching fabric.

Like reference numerals will be used to represent like elements.

### DETAILED DESCRIPTION

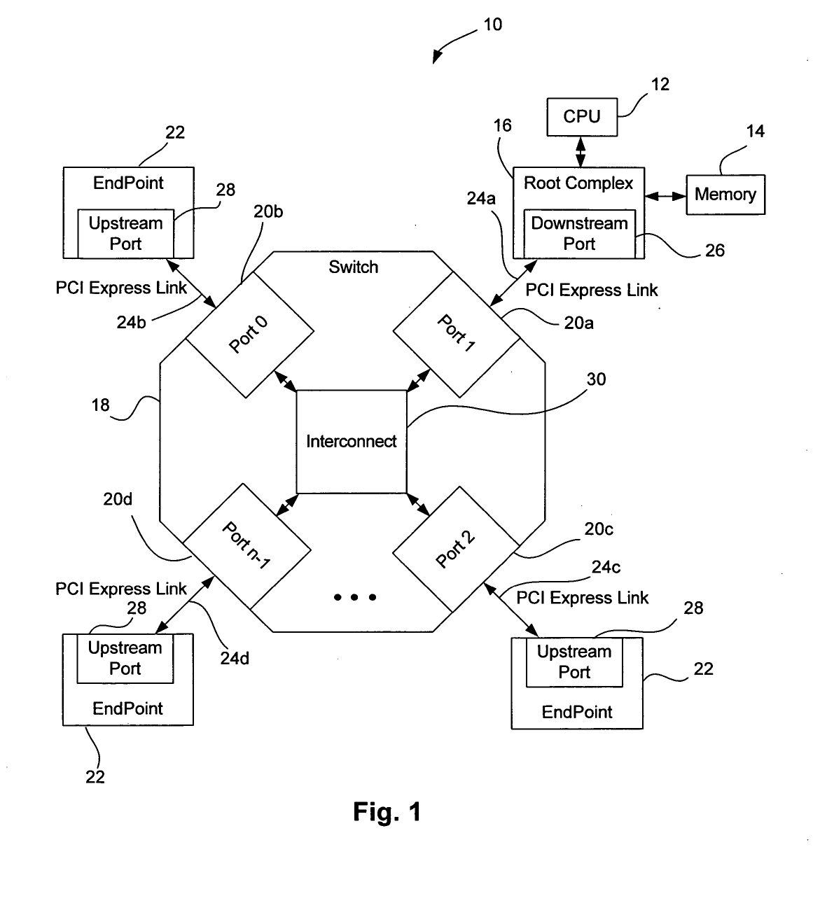

FIG. 1 shows a system 10 implemented as a Peripheral Component Interconnect (PCI) Express processing platform based on the PCI Express architecture. The PCI Express architecture is described in the PCI Express Base Specification, Rev. 1.0a, Apr. 15, 2003 (hereinafter, “PCI Express Base Specification”). The processing platform 10 includes a central processing unit (CPU) 12 coupled to a system memory 14 by a root complex (RC) 16 to provide a host processing system. Also included in the processing platform 10 is a switch 18. The switch 18 includes a number of ports 20, with at least one port being connected to the root complex 16 and at least one other port being coupled to an “endpoint” 22. The endpoint 22 may be a PCI Express endpoint or a legacy endpoint, as provided in the PCI Express Base Specification. The RC 16, switch 18 and endpoints 22 are referred to herein as “PCI Express devices”, as they are based on the architecture defined in the above-mentioned PCI Express Base Specification.

In the illustrated embodiment of FIG. 1, the switch 18 includes “n” ports, labeled as “port 0”, “port 1”, “port 2”, . . . , “port n−1”. Ports 1, 0, 2 and n−1 are indicated by reference numerals 20a, 20b, 20c and 20d, respectively. The switch ports 20 are connected to non-switch ports via corresponding PCI Express links 24. Links shown in the figure include link 24a (connected to switch port 20a), link 24b (connected to switch port 24b), link 24c (connected to switch port 20c) and link 24d (connected to the “n-ith” switch port, that is, switch port 20d). The link 24a connects switch port 1 to a root complex port 26. The other links connect switch ports 0 and 2 through n−1 to ports in the endpoints 22, shown as endpoint ports 28. Also provided in the switch 18 is an interconnect 30 that allows each switch port 20 to communicate with each of the other switch ports 20. The interconnect 30 includes an internal switch fabric as well as inter-port communication logic, to be described later.

The switch 18 enables communications between the RC 16 and endpoints 22, as well as peer-to-peer communications between the endpoints 22. The switch 18 may be implemented within a component or chipset that also contains the RC 16, or it may be implemented as a separate component. The endpoints 22 may be devices that include, for example, a mobile docking device, a network interface card, video output device, audio output device, and the like when the system 10 is, for example, a desktop computing system. Alternatively, if the system 10 is a networking communications system, the endpoints 22 each may each be implemented as a line card. Although not shown, it will be appreciated that additional endpoint devices, such as graphics cards, may be connected to the RC directly. Although not shown, a switch port could be connected to another switch as well.

In keeping with the terminology set forth by the PCI Express Base Specification, the following terminology is adopted herein: the RC 16 is referred to as an “upstream device”; each endpoint 22 is referred to as a “downstream device”; the root complex port 26 is referred to as a “downstream port”; the switch port 20a (port 1) connected to the upstream device is referred to as an “upstream port”; switch ports 0 and 2 through n−1 connected to downstream devices are referred to as “downstream ports”; and the endpoint ports 28 connected to the downstream ports of the switch 18 are referred to as “upstream ports”. The link between the downstream port of the upstream device and the upstream port of a downstream device is configured by logic circuitry in each port.

The switch 18 employs a dynamic upstream port selection. In one embodiment, to be described, the switch 18 utilizes a link training process (based on the link training process described in the PCI Express Base Specification) in determining which switch port is at the opposite end of a link from the upstream device, that is, the RC 16. The dynamic upstream port selection mechanism allows any one of the switch ports 20 to be used as the upstream port. In the example shown, port 1 is connected to the upstream device, but any other port, for example, port n−1, could have been connected to the upstream device instead.

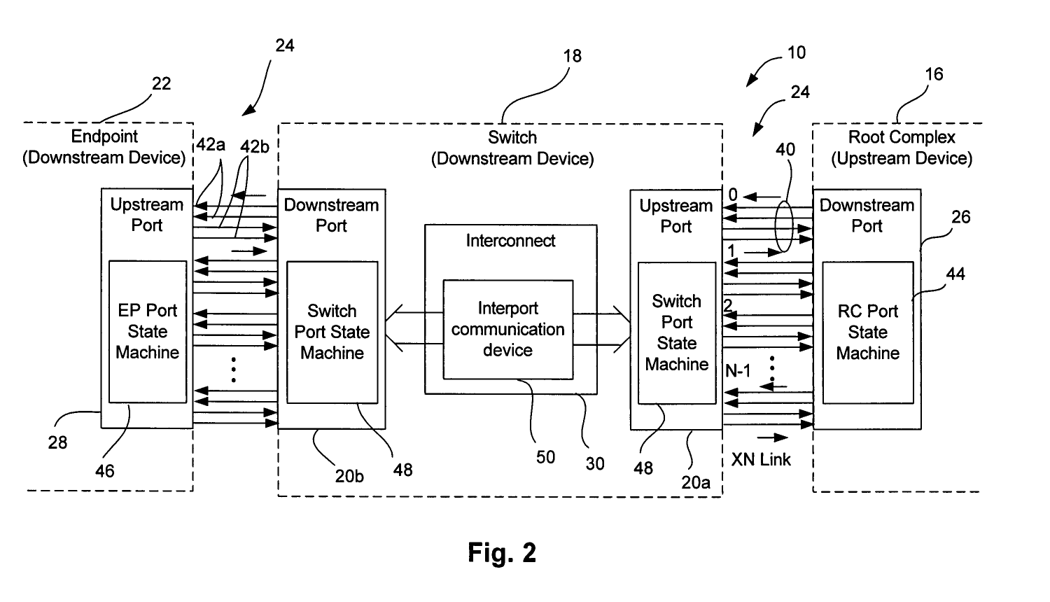

FIG. 2 shows the links 24 and switch ports 20 in greater detail. For simplification, only one link between a representative one of each of the different PCI Express devices 16, 18, 22 of system 10 is shown. Referring to FIG. 2, the link 24 between ports of any two PCI Express devices (again, devices RC 16, switch 18 and endpoint 20) includes one or more lanes 40 for a “x N” link. Each lane 40 consists of two differentially driven signal line pairs, a first pair of differentially driven signal lines 42a for the transmit direction and a second pair of differentially driven signal lines 42b for the receive direction. At minimum, a link supports one lane, and additional lanes may be added to provide additional link bandwidth.

The physical layer in the ports of each of the PCI Express devices includes a control process, referred to as a link training process, that configures each link for normal operation. The link training process configures individual lanes into a functioning link. In the RC port (downstream port) 26 this process is implemented as an RC port state machine 44. In the endpoint port (upstream port) 28 this process is implemented as an endpoint (EP) port state machine 46. In the switch upstream port and downstream ports 20 this process is implemented as a switch port state machine 48. The state machines for the RC port 26 and endpoint port 28 may be implemented to follow the PCI Express Base Specification, in particular, the Link Training and Status State Machine (LTSSM) for downstream port/lanes and upstream port/lanes, respectively. Much of the following discussion will focus on the operation of the switch port state machine 48, which includes additional logic beyond that which is described in the PCI Express Base specification for the LTSSM to support the dynamic upstream port selection.

The switch port state machine 48 in each port 20 incorporates logic to support aspects of both upstream and downstream port behavior. The logic is defined so that each port operates as an upstream port initially, at the beginning of link training. During the link training, and based on whether the port is connected to an upstream device or a downstream device, the port will either determine that it is an upstream port and direct the other ports to convert to downstream port behavior (if the port is, in fact, connected to an upstream device), or will receive direction from another port (the actual upstream port) to convert itself to a downstream port (if the port is connected to a downstream device).

Included in the switch interconnect 30 is an inter-port communication device 50 that allows any switch port that is connected to an upstream device to signal to another switch port to behave as a downstream port. The inter-port communication device 50 can be implemented in any number of different ways. It may be a simple logic circuit devised to assert a control signal, a message-based communication mechanism, or an intelligent processor that receives an interrupt from the upstream port and responds by signaling the other ports to “switch over” to downstream port behavior, to give but a few examples.

The operation of the physical layer within each PCI Express device port is defined by different logic states of that port's respective state machine and the associated link. The logic states are defined as “link states”. Before normal link operation of transferring packets between two PCI Express devices can begin, the state machines within each port must execute the link training process defined by those state machines.

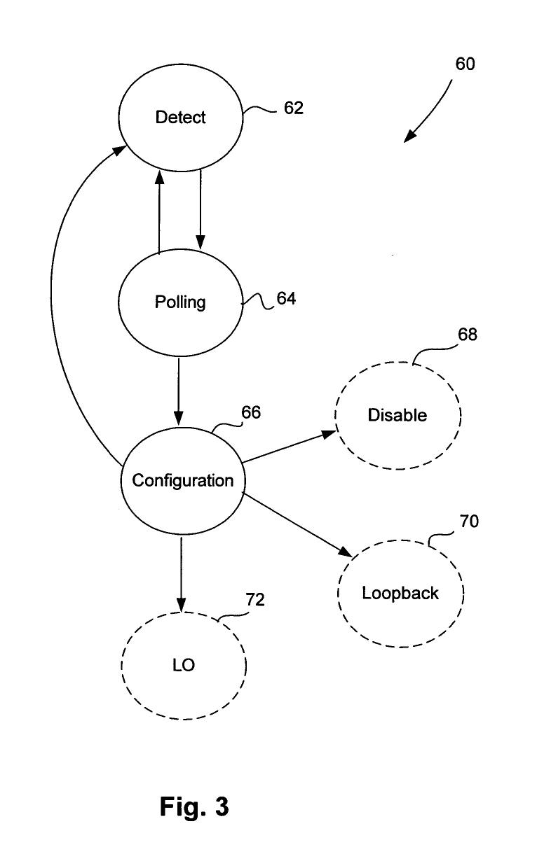

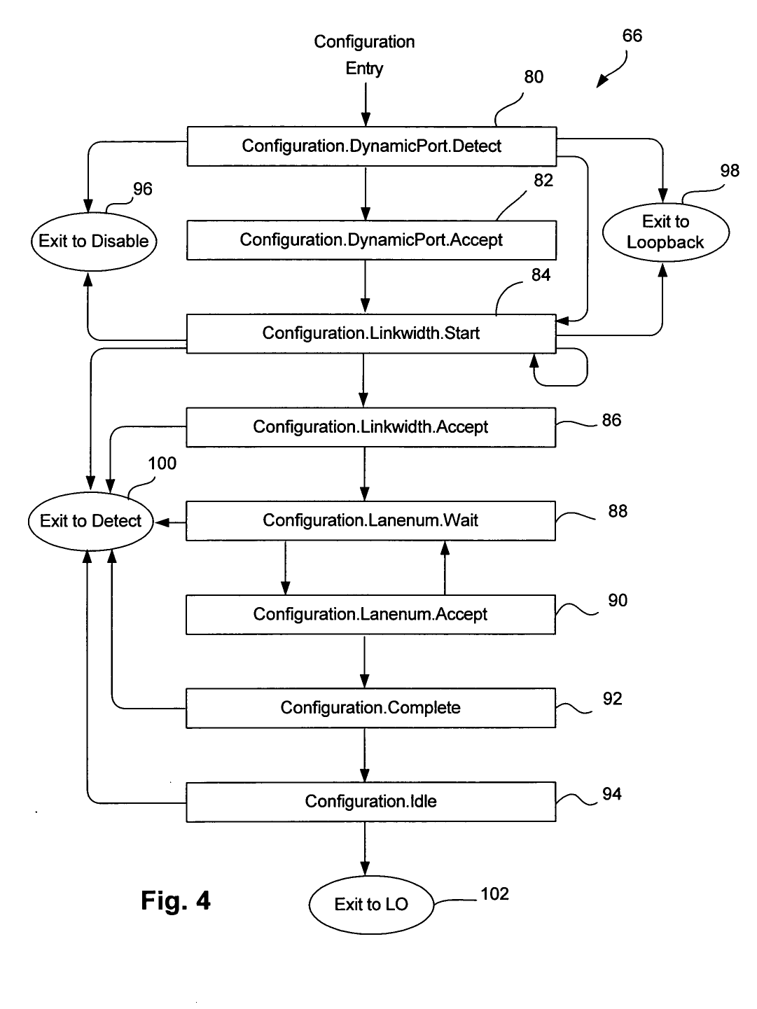

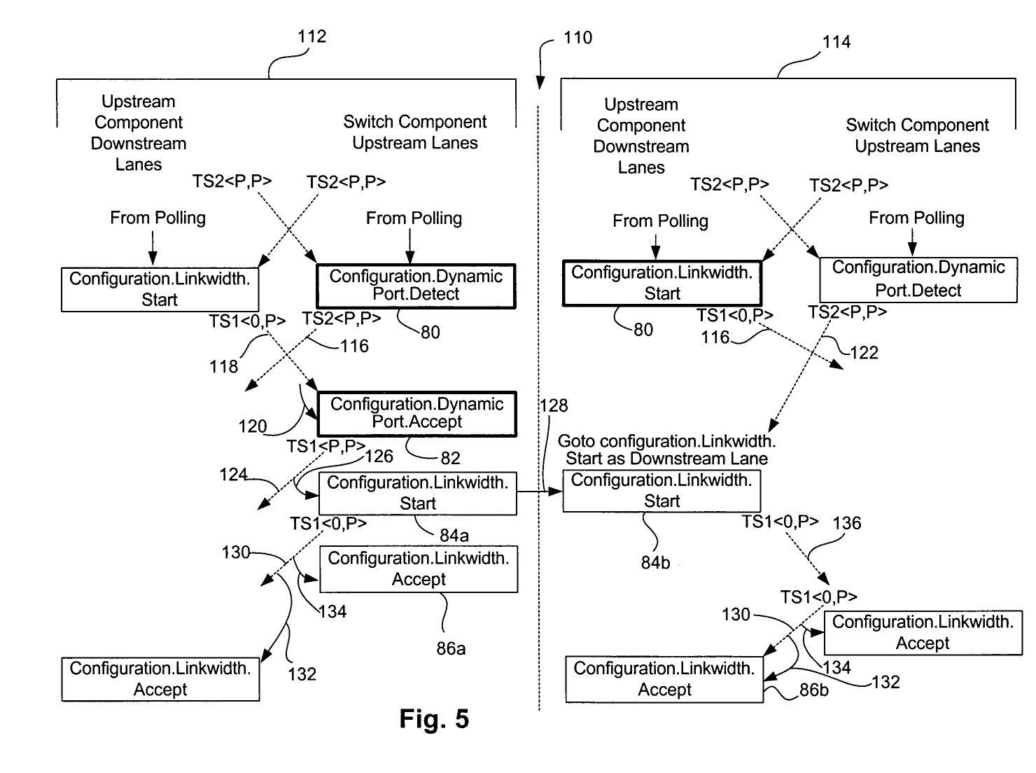

The operation of a state machine may be represented graphically in a state diagram. In the state diagram shown in FIG. 3, a state is represented by a circle, and the transition between states is indicated by directed lines connecting the circles. In the sub-state machine diagrams of FIGS. 4 and 5, a sub-state is represented by a rectangular box, and the transition between sub-states is indicated by directed lines connecting the boxes. The state machine may be implemented in sequential circuitry according to known logic design techniques.

Referring now to FIG. 3, training the link requires an understanding of the link data rate, link width and lane ordering, among other factors. The primary link states of a link training process 60 for configuring a link by a switch port include a Detect state 62, a Polling state 64 and a Configuration state 66. The Detect state 62 establishes the existence of a PCI Express device on the opposite end of the link. The Polling state 64 establishes the bit and symbol lock, lane polarity inversion and highest common data bit rate on the detected but yet-to-be configured lanes that exist between the two PCI Express devices. The Configuration state 66 processes the detected lanes that completed the Polling link sub-states into configured lanes. Additional link training states Disable 68 and Loopback 70, as well as Recovery and Hot Reset (not shown) are as described in the PCI Express Base Specification. For simplification, lines indicating other transitions to/from Detect and Polling are not shown in the figure. Also omitted are transitions to Configuration from states other than Polling. An L0 state 72, which follows Configuration, is the normal operational state where data and control packets can be transmitted and received. Link training thus sequences through the Detect, Polling and Configuration link states.

The first state the state machine enters is the Detect state 62. It may be entered upon cold reset (power-up), warm reset or if the protocol of the Configuration state 66 fails to establish a configured link. It is also transitioned into if the other link states do not succeed. The Detect state 62 determines whether or not there is a device connected on the other side of the link.

The Polling state 64 and the Configuration state 66 both use training instructions referred to as training sequence ordered sets (OSs). Training sequence OSs are used for bit and symbol alignment, to configure lanes and to exchange physical layer parameters. The establishment of the number of configured lanes also establishes the link width. The OSs are defined as a group of sixteen 8-bit/10-bit encoded special characters and data (symbols), that is, symbols 0 through 15. Symbol 0 is used for bit alignment. Symbol 1 is the link number within a device and symbol 2 is the lane number within a port. Symbol 3 is required for bit and symbol lock. Symbol 4 is a data rate identifier, and symbol 5 is used for training control. The symbols 6-15 are used for training OS identifiers (to distinguish between TS1 and TS2). Some sub-states use TS1 and others use TS2.

The symbols include what are referred to as “K” and “D” symbols. The D symbols carry bytes associated with the link packets generated by the data link layer. The K symbols are special characters used for framing and other purposes. The K symbols include a PAD K symbol that is used for symbol time filler in ×8 and greater link widths, and that is also used in link width negotiations.

The sub-states of the Configuration state 66 establish link width and lane ordering, among other tasks. The Configuration state 66 is an iterative process of several sub-states. The iterative process includes the application of training sequence OSs. The discussion of the Configuration state 66 will assume that the Detect and Polling states (states 62, 64) have established a set of detected un-configured lanes common to both PCI Express devices on a link.

FIG. 4 shows a sub-state machine for the Configuration state 66. Upon entering the Configuration state, the following sub-states are performed: ‘Configuration.DynamicPort.Detect’ 80; ‘Configuration.DynamicPort.Accept’ 82; Configuration.Linkwidth.Start’ 84; Configuration.Linkwidth.Accept’ 86; ‘Configuration.Lanenum.Wait’ 88; Configuration.Lanenum.Accept’ 90; Configuration.Complete’ 92; and ‘Configuration.Idle’ 94. Under certain conditions the sub-state machine may exit the Configuration state to other states, including Disable, Loopback, Detect and L0, via exit points 96, 98, 100 and 102, respectively. Various sub-states, in particular, sub-states 86, 88, 90, 92 and 94, are subject to a timeout period. If no activity occurs during the timeout period, the sub-state machine exits to the Detect state 62 (as indicated by ‘Exit to Detect 100′).

The operation of the switch port Configuration state will be described with reference to FIG. 4 and FIG. 5. FIG. 5 shows inter-device link training interactions 110 including interactions between the switch upstream port and the upstream device (indicated by reference number 112) and interactions between the switch downstream port and the downstream device (indicated by reference number 114) during a first half of the Configuration sub-state sequence. In FIG. 5, the dashed lines/arrows are intended to represent OS transmissions, the solid lines/arrows are intended to represent sub-state transitions (based on outgoing or incoming OS transmissions) and the shorthand expression ‘TSx<y,z>’ is used to convey the type of OS, where x is ‘1’ or ‘2’, y is ‘P’ (for PAD) or a non-PAD value indicating a link number, for example, ‘0’, and z is ‘P’ or a non-PAD value indicating a lane number. In FIG. 5 some of the reference numerals associated with sub-states include an ‘a’ or a ‘b’ to distinguish sub-state activities in the switch ports that differ depending on whether the switch ports are connected to upstream or downstream devices.

Referring now to FIG. 4 in conjunction with FIG. 5, upon Configuration state entry, the sub-state machine first performs ‘Configuration.DynamicPort.Detect’ 80. In this sub-state TS2 ordered sets with link and lane number symbols set to PAD (K23.7) are transmitted on all lanes for which a receiver was detected (as indicated by arrow 116). The sub-state machine exits to Disable (indicated by reference number 96) after any lanes for which a receiver was detected, and that are also receiving TS1 ordered sets, receive two consecutive TS1 OSs in which the Disable bit is asserted. The sub-state machine exits to Loopback (indicated by reference number 98) after any lanes that detected a receiver during Detect, and that are also receiving TS1 OSs, receive two consecutive TS1 ordered sets in which the Loopback bit is asserted. If the sub-state machine is directed to disable the link (by exiting to Disable) or enter Lookback, the sub-state machine enters that state and causes the other device on the link to do likewise.

If any lanes receive two consecutive TS1 ordered sets with link numbers that are different than the PAD and lane numbers set to PAD (as indicated by arrow 118), the sub-state machine advances to ‘Configuration.DynamicPort.Accept’ 82 (indicated by arrow 120). As illustrated in FIG. 5, only the actual upstream port (of the switch) will advance to this state, as only that port is connected to the upstream device that transmits the OSs containing the link number. The downstream port instead receives from the downstream device OSs with PAD values in the link and lane number fields (as indicated by arrow 122). Thus, the downstream port will not transition to the state 82 like its upstream counterpart.

A port that has transitioned to the ‘Configuration.DynamicPort.Accept’ sub-state 82, transmits eight consecutive TS1 OSs with the link and lane number fields set to PAD (as indicated by arrow 124). It will be noted that sending more or less than 8 TS1 OSs is permissible; however, the receiver must observe at least one TS1 OS with link and lane numbers set to PAD in order to proceed with the link training. The sub-state machine transitions from the Configuration.DynamicPort.Accept’ sub-state 82 to sub-state ‘Configuration.Linkwidth.Start 84a’ (as indicated by arrow 126), continuing to operate as an upstream port.

Referring back to the Configuration.DynamicPort.Accept’ sub-state 82, the port while in this sub-state also directs all other ports to proceed to ‘Configuration.Linkwidth.Start’ 84b as downstream ports (an inter-port communication within the switch indicated by reference numeral 128). Thus, for a port connected to a downstream device, the next state to follow ‘Configuration.DynamicPort.Detect’ 80 is Configuration.Linkwidth.Start 84b. The sub-state machine will transition from sub-state 80 to sub-state 84b if directed by another port to assume operation as a downstream port.

If the port has entered the ‘Configuration.Linkwidth.Start’ sub-state 84a, the port transmits consecutive TS1 OSs to the upstream device with the selected link numbers (and the lane numbers still set to ‘PAD’)(indicated by arrow 130). The transmission of two consecutive TS1 OSs with a non-PAD value in the link number symbol causes the upstream device to advance to the next state for downstream port/lanes (indicated by arrow 132) and the switch port to transition to the Configuration.Linkwidth.Accept sub-state 86a for switch upstream port/lanes (indicated by arrow 134). If nothing happens within a 24 ms timeout window while the sub-state machine is in the sub-states 84 or 86, the port enters back into the Detect state 62.

While in the Configuration.Linkwidth.Start sub-state 84b, the sub-state machine transmits to the downstream device TS1 OSs that specify a non-PAD link number and a PAD lane number (indicated by arrow 136). The downstream device will echo these TS1 OSs back to the switch port (as indicated by arrow 138), which causes both the switch port sub-state machine to advance to the Configuration.Linkwidth.Accept sub-state 86b (as indicated by arrow 140). It also causes a transition (indicated by arrow 142) to the corresponding sub-state in the downstream device to occur. It should be noted that the sub-state machine may be directed to exit to Disable or exit to Lookback in the Configuration.Linkwidth.Start sub-state 84 as well, as indicated in FIG. 4.

Referring to FIG. 4, following the link number establishment, the switch port Configuration sub-state machine sequences through the sub-states 88 and 90 to negotiate lane numbering. During the Configuration.Complete sub-state 92, additional information is used to determine lane-to-lane skew parameters, as well as other parameters. When the Idle sub-state 94 is reached, the link and lane numbering are fixed, and so the link is considered to be fully configured. Once the link is configured, the sub-state machine exits to the L0 state to begin normal operation.

It will be appreciated from the illustrations of FIGS. 4 and 5 that the Configuration sub-state machines in the upstream and downstream ports of the switch are defined such that both types of ports begin operation (during the link training) behaving as upstream ports. They both perform the Configuration.DynamicPort.Detect sub-state 80. Only the actual upstream port, because it is receiving OSs from the upstream device, will transition to the Configuration.DynamicPort.Accept 82 to acknowledge its role as an upstream port, which requires that it direct other ports, which are actually downstream ports, to convert to downstream port behavior (beginning with the Configuration.Linkwidth.Start substate 84b defined for downstream port/lanes).

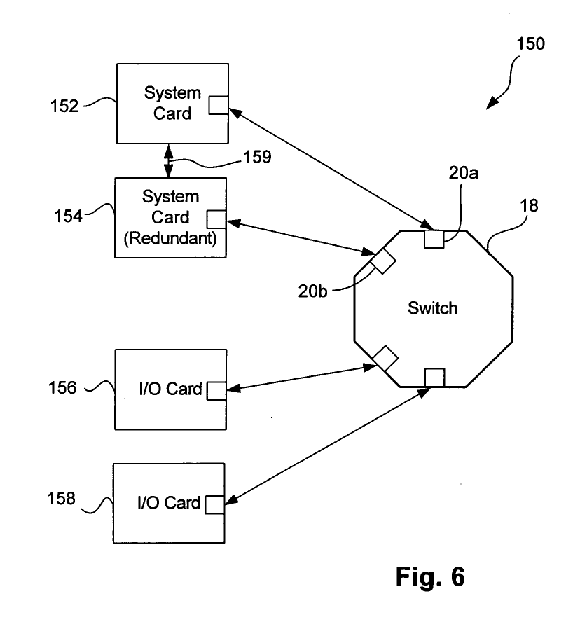

The dynamic upstream port selection mechanism can be used to implement redundant system slot type applications, for example, those in Advanced Telecom and Computing Architecture (ATCA) or CompactPCI environments. Referring to FIG. 6, an exemplary redundant system slot implementation 150 including a first system card 152, a second system card 154, along with I/O cards 156, 158, is shown. At power on, the two system cards 152, 154 communicate via side band signals 159 to determine which card will be the active card and which will be the redundant (or standby) card. With dynamic upstream port selection, as described above, the switch 18 recognizes the active system card, for example, system card 152, as the root complex. Thus, the switch port connected to the root complex, switch port 20a, directs the switch port that connects to the redundant system card 154, shown as switch port 20b, to be converted to a downstream port. It will be appreciated that the redundant system card may be designed for dual use, to function as the root complex if fail-over occurs, and to function as an I/O device when the system card would otherwise be in a stand-by mode.

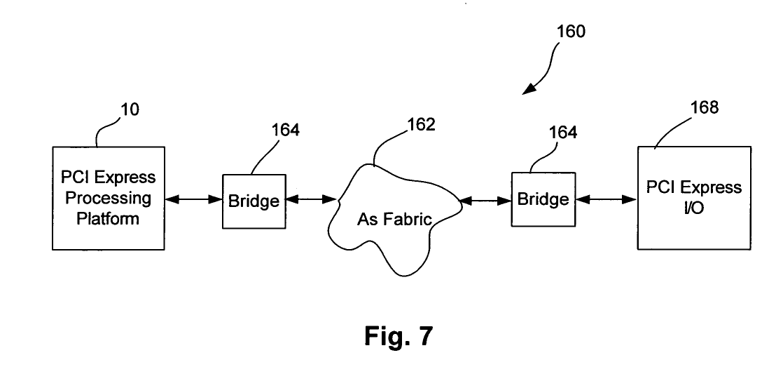

The PCI Express switch with dynamic upstream port selection, as described herein, may be included in any number of different systems and system environments. For example, the switch 18 may be incorporated in a PCI Express processing platform, with various endpoint add-in cards, for use as a desktop system, server or networking communications system, as mentioned earlier. In yet another application, as illustrated in FIG. 7, the switch 18 with dynamic upstream port selection may be used in a processing environment 160 in which a PCI Express processing platform such as the PCI Express processing platform 10 (from FIG. 1) is connected to an Advanced Switching (AS) fabric 162 by a PCI Express to AS bridge 164. On the other side of the AS fabric 162, a PCI Express I/O device or sub-system 168 is coupled to the AS fabric 162 by a second PCI Express to AS bridge 164. In this environment, a CPU in the PCI Express processing platform can communicate with the PCI Express I/O of device (or sub-system) 168 via the AS fabric 162. This type of configuration may have applicability in environments in which the communication model involving CPU and I/O is more sophisticated, e.g., storage, blade servers, clusters, video servers, medical imaging, and so forth.

The dynamic upstream port selection has a number of advantages. For example, it simplifies switch usage in a cabled environment. If the port upstream/downstream port allocation is dynamic, then the switch user has flexibility in selecting which switch port to connect to the system root complex. Additionally, the mechanism supports redundant host systems by enabling a alternate root complex to be brought on line without changes to the switch or system board.

Other embodiments are within the scope of the following claims.

1. A switch comprising:
ports defined to begin operation as upstream ports;
control circuitry, associated with each port, to perform a link training sequence to configure a PCI Express link after the port is connected to such link; and
wherein the link training sequence is defined to determine if the PCI Express link connects to an upstream device and, if having so determined, to cause the port to direct each other port to operate as a downstream port.

2. The switch of claim 1 wherein the control circuitry comprises a state machine that includes a configuration sub-state machine in which a first sub-state determines if the PCI Express link connects to an upstream device and a second sub-state causes the port to direct each other port to operate as a downstream port.

3. The switch of claim 2 wherein the configuration sub-state machine is defined to transition from the first sub-state to the second sub-state if, while in the first sub-state, the port receives a pre-determined number of training sequence ordered sets in which a link number symbol is set to a value other than a PAD value.

4. The switch of claim 2 wherein the configuration sub-state machine is defined to include a third sub-state with logic defining downstream port behavior and logic defining upstream port behavior.

5. The switch of claim 4 wherein the third sub-state logic defining downstream port behavior is transitioned to following the first sub-state if the port is directed to operate as a downstream port by another port.

6. The switch of claim 4 wherein the third sub-state logic defining upstream port behavior is transitioned to following the second sub-state.

7. The switch of claim 4 wherein the third sub-state comprises a linkwidth.start sub-state.

8. A device comprising:
a root complex;
a switch, coupled to the root complex by a first PCI Express link, including a port being connected to the first PCI Express link and further including a port to connect to a second PCI Express link to couple the switch to an endpoint;
each of the ports being defined to begin operation as an upstream port;
control circuitry, associated with each port, to perform a link training sequence to configure the respective first and second PCI Express links once connected; and
wherein the link training sequence is defined to determine if the PCI Express link connects to an upstream device and, if having so determined, to cause the port to direct the other port to operate as a downstream port.

9. The device of claim 8 wherein the control circuitry comprises a state machine that includes a configuration sub-state machine in which a first sub-state determines if the PCI Express link connects to an upstream device and a second sub-state causes the port to direct the port to operate as a downstream port.

10. The device of claim 9 wherein the configuration sub-state machine is defined to transition from the first sub-state to the second sub-state if, while in the first sub-state, the port receives a pre-determined number of training sequence orders sets in which a link number symbol is set to a value other than a PAD value.

11. The device of claim 9 wherein the configuration sub-state machine is defined to include a third sub-state with logic defining downstream port behavior and logic defining upstream port behavior.

12. The device of claim 11 wherein the third sub-state logic defining downstream port behavior is transitioned to following the first sub-state if the port is directed to operate as a downstream port.

13. The device of claim 11 wherein the third sub-state logic defining upstream port behavior is transitioned to following the second sub-state.

14. The device of claim 11 wherein the third sub-state comprises a linkwidth.start sub-state.

15. The device of claim 8 further comprising a second root complex coupled to the root complex in a redundant root complex configuration, and wherein the switch comprises a port that is connected to the second root complex by a third PCI Express link.

16. The device of claim 15 wherein the port that is connected to the third PCI Express link is selected as a downstream port during the link training sequence when the root complex is active and the second root complex is in standby mode.

17. The device of claim 16 wherein the first port, second and thirds ports are defined so that, after a fail-over in which the second root becomes active and the root complex is placed in the standby mode, during a link training sequence, the port that is connected to the third PCI Express link is selected to operate as the upstream port.

18. A processing platform comprising:
a switch including a first port and a second port;
a root complex connected to the first port by a first PCI Express link;
an endpoint connected to the second port by a second PCI Express link;
wherein the switch is defined to dynamically select the first port to operate as an upstream port and the second port to operate as a downstream port.

19. The processing platform of claim 18 wherein the first port and the second port are defined so that the first port, once selected as the upstream port, causes the second port to operate as a downstream port.

20. The processing platform of claim 19 wherein the dynamic selection occurs during a link training sequence.

21. The processing platform of claim 20 wherein the switch further includes a third port, further comprising a second root complex connected to the third port by a third PCI Express link, the second root complex coupled to the root complex in a redundant configuration, and wherein the third port is selected as a downstream port during the link training sequence when the root complex is active and the second root complex is in standby mode.

22. The processing platform of claim 21 wherein the first, second and thirds ports are defined so that, after a fail-over in which the second root complex becomes active and the root complex is placed in the standby mode, during a link training sequence, the third port is selected to operate as the upstream port, and the first and second ports are selected to operate as a downstream ports.

23. The processing platform of claim 18 wherein the dynamic selection occurs during a link training sequence.

24. The processing platform of claim 18 wherein the root complex comprises a system card and the endpoint comprises an I/O card.

25. A system comprising:
a processing platform, comprising:
a switch including a first port and a second port;
a root complex connected to the first port by a first PCI Express link;
an endpoint connected to the second port by a second PCI Express link;
wherein the first port is defined to dynamically select the first port as an upstream port and the second port as a downstream port; and
a bridge, connected to the endpoint, to couple the processing platform to an Advanced Switching fabric.

26. The system of claim 25 wherein the dynamic selection occurs during a link training sequence to configure the first PCI Express link

27. A method comprising:
operating ports in a PCI Express switch as upstream ports at the beginning of a link configuration; and
during the link configuration, causing at least one port to be directed to operate as a downstream port.

28. The method of claim 27 wherein the ports in the PCI Express switch include a port connected to an upstream device, and wherein the at least one port directed to operate as a downstream port is so directed by the port connected to the upstream device.

29. The method of claim 27 wherein the link configuration comprises a link training sequence.

30. The method of claim 27 wherein the link training sequence includes a configuration state in which a first sub-state determines that the port is connected to an upstream device and a second sub-state in which causes the port directs the at least one port to operate as a downstream port.
